(19) United States
(12) Patent Application Publication
(10) Pub. No.: US 2023/0034522 A1
(43) Pub. Date: Feb. 2, 2023

(54) SIGNAGE ATTACHMENT SYSTEM AND METHOD

(71) Applicant: Dennis James Wilson, Forestville, NY (US)

(72) Inventor: Dennis James Wilson, Forestville, NY (US)

(21) Appl. No.: 17/815,693

(22) Filed: Jul. 28, 2022

Related U.S. Application Data
(60) Provisional application No. 63/226,545, filed on Jul. 28, 2021.

(51) Int. Cl. G09F 7/18; F16B 19/00

(52) U.S. Cl. CPC G09F 7/18; F16B 19/00; G09F 2007/1856

(57) ABSTRACT

A tree fastener and method of connecting an object to a tree is disclosed herein. The method generally includes steps. A fastener is provided that includes a head, a non-threaded shaft and a polymer material. A hole is formed in the tree. The object is positioned against the tree proximal the hole. The fastener is inserted through the object such that: the head of the fastener substantially abuts the object, the object substantially abuts bark of the tree, and the shaft terminates at a first growth ring of the tree. Once installed, the fastener maintains the object in connection with the tree over time as the tree grows additional growth rings.

### CROSS-REFERENCE TO RELATED APPLICATION

This application claims the benefit of priority of U.S. provisional application No. 63/226,545, filed Jul. 28, 2021, the contents of which are herein incorporated by reference.

### BACKGROUND OF THE INVENTION

The present invention relates to objects supported by trees and, more particularly, to a system and method of fastening objects (such as signs, trail markers, etc.) to living trees which allows them to grow without shedding the object (i.e., pushing the object off the tree).

When something is nailed or screwed to a growing tree, the shaft of the fastener (e.g., a nail or a screw) is held fast due to rust or friction. As a result, as the tree grows, the head of the fastener is engulfed by the increasing tree diameter, causing the attachment to fail.

Most currently used fasteners adhere or are fixedly coupled to the wood of the tree and the friction prevents them from adjusting as the tree grows. They also have other pitfalls. For example, other products can corrode which can cause them to fail and/or become unsightly. They can also stain the wood if the tree is ever sawn into lumber. Axe blazes used to mark trails or boundaries are temporary, unsightly and create wounds in the tree, allowing entry of fungi or insects. They also create large defects, should the tree ever be harvested for timber.

As can be seen, there is a need for a method and system for fastening objects to a tree in a permanent fashion that does not fail. In accordance with the present invention, a fastener is disclosed that is non-ferrous which, in the event the tree is sawed, won't endanger the operator, or damage the saw. The present invention can be produced in many colors and sizes to suit any application.

### SUMMARY OF THE INVENTION

In one aspect of the present invention, a method of connecting an object to a tree is disclosed, with the method including the steps of: providing a fastener including a head, a non-threaded shaft and a polymer material; forming a hole in the tree; positioning the object against the tree proximal the hole; inserting the fastener through the object such that: the head of the fastener substantially abuts the object, the object substantially abuts bark of the tree, and the shaft terminates at a first growth ring of the tree, whereby the fastener maintains the object in connection with the tree. As those with skill in the art, the present invention also includes a fastener configured to function in a manner described herein and recited in the appended claims.

As stated above, when an object is nailed or screwed to a growing tree, the shaft of the nail is held fast due to rust or friction. As a result, as the tree grows the head is engulfed by the increasing diameter, causing the attachment to fail. The present invention claimed here solves this problem.

Devices in accordance with the present invention are non-metallic or non-ferrous, generally maintenance-free, relatively attractive, and can be produced in many colors or sizes to match a variety of applications. Being either polymer or nonferrous, the present invention will not damage saws or endanger operators should the tree be cut. Given that it will far outlast screws or nails, it will reduce the labor and material maintenance cost.

In preferred embodiments, the present invention is made of a strong polymer or non-ferrous metal which is self-lubricating or lubricated. It is provided with a large head, which distributes the force applied by the growing cambium layer and withdraws the shaft of the fastener (i.e., it slowly slides out in conjunction with the outermost portion of the tree 11) instead of pulling the head through the attached object. As the polymer shaft is withdrawn, a void is created behind it. The tree is thus able to increase in diameter considerably as a result.

The present invention differs from what currently exists. As described, most currently used fasteners adhere to the wood of the tree and the friction prevents them from adjusting as the tree grows. Due to this, the signs, markers, and other objects being attached by existing fasteners (e.g., nails, screws, etc.) are shed, necessitating replacement and labor. In addition, trees containing metal hardware are a danger to saws and operators and may be unsightly. In comparison, the present invention is configured to move as the tree grows while staying attached to the tree and does not deteriorate substantially in appearance.

These and other features, aspects and advantages of the present invention will become better understood with reference to the following drawings, description, and claims.

### BRIEF DESCRIPTION OF THE DRAWINGS

The following figures are included to illustrate certain aspects of the present disclosure and should not be viewed as exclusive embodiments. The subject matter disclosed is capable of considerable modifications, alterations, combinations, and equivalents in form and function, without departing from the scope of this disclosure.

FIG. 1 is a top perspective view of an embodiment of the present invention;

FIG. 2 is a bottom perspective view of the embodiment of the present invention;

FIG. 3 is a top plan view of the embodiment of the present invention;

FIG. 4 is a front perspective view of the embodiment of the present invention, shown in use with a tree;

FIG. 5 is a cross-sectional view of the embodiment of the present invention, indicated by line 5-5 of FIG. 4;

FIG. 6 is a cross-sectional view of the embodiment of the present invention, similar to FIG. 5, showing a later stage of growth of the tree, (i.e. depicting new growth rings, as well as showing the earlier growth rings of FIG. 5); and

FIG. 7 is cross-sectional view, similar to FIG. 5, of a modified version of the embodiment of the present invention.

### DETAILED DESCRIPTION OF THE INVENTION

The subject disclosure is described with reference to the drawings, wherein like reference numerals are used to refer to like elements throughout. In the following description, for purposes of explanation, numerous specific details are set forth in order to provide a thorough understanding of the present disclosure such that one skilled in the art will be enabled to make and use the present invention. It may be evident, however, that the present disclosure may be practiced without some of these specific details. For the purpose of clarity, technical material that is known in the technical fields related to the present invention has not been described in detail so that the present invention is not unnecessarily obscured.

Broadly, one embodiment of the present invention is a fastener formed from a high-strength polymer that is self-lubricating or lubricated. The fastener includes a shaft and a head. The shaft may be embodied as a cylindrical strong polymer shaft of varying diameter and length. One end of the shaft may be pointed or chamfered to allow easy insertion into a pre-drilled hole in the tree. The head may be embodied as a large head that will distribute the force of the growing tree, thereby preventing it from being pulled through the attached object.

In certain embodiments, the polymer is a high-density polyethylene material. It has a large head, which distributes the force applied by the growing cambium layer of the tree and withdraws the shaft of the fastener, instead of pulling the head through the attached object (that the fastener is supporting). As the polymer shaft is withdrawn, a void is created behind it. The tree can increase in diameter considerably as a result without the fastener becoming dislodged or broken.

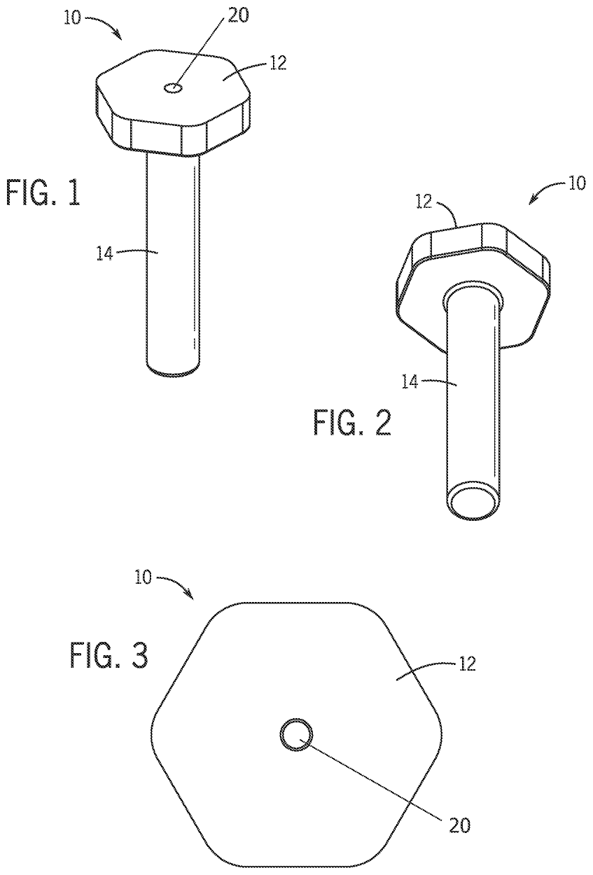

Referring now to FIGS. 1-3, a polymer fastener 10 is generally shown. It is generally in the form of a pin, and the fastener 10 includes a head 12 and shaft 14 (which is non-threaded) extending from the head 14. As shown, the head 12 is large (i.e., is wide and has substantial thickness) to resist deformation or breaking while in use. In certain embodiments, the head 12 may be approximately 1 inch in diameter and 0.25 inches thick, and the shaft 14 may be approximately 2 inches long and 0.37 inches in diameter. The shaft 14 and head 12 may be formed as a single unit by any appropriate method, such as injection molding or extrusion.

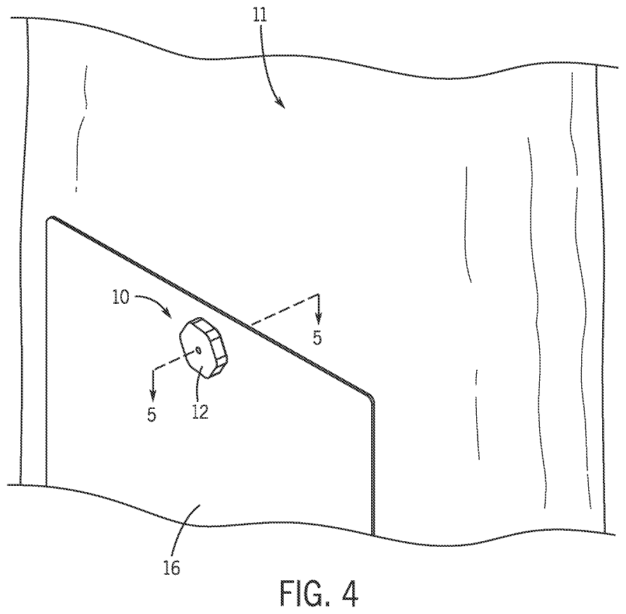

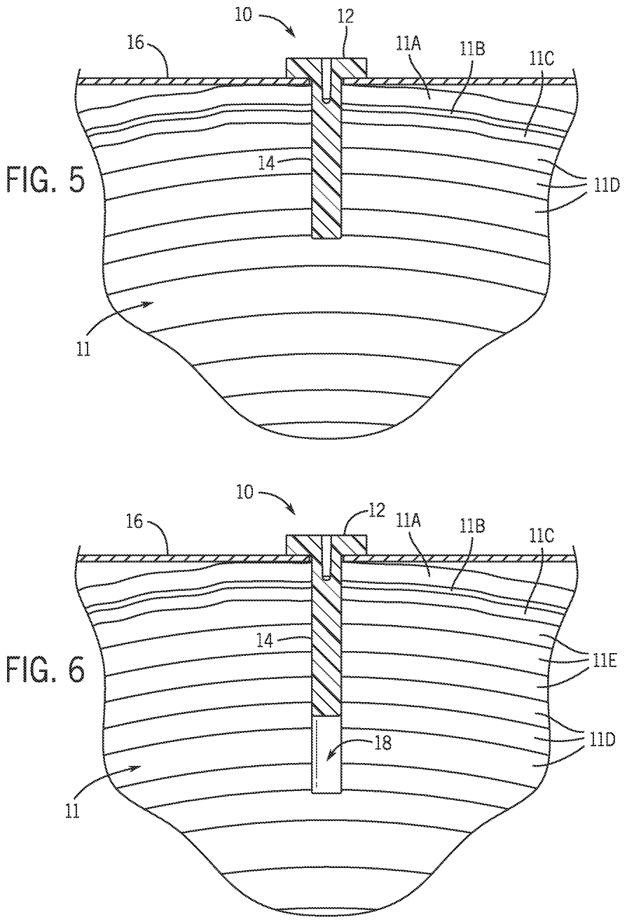

As shown in FIGS. 4-6, in use, the fastener 10 connects an object 16 (such as a sign) to a tree 11. The shaft 14, which is lubricated or self-lubricating, is capable of sliding in the trunk of the tree 11 as it grows. By way of example, take FIG. 5, which represents the tree 11 when the fastener 10 and object 16 are first connected to the tree 11. At this point in time, the tree 11 includes outer bark 11A, a cambium layer 11B, inner bark 11C, and first growth rings 11D.

To connect the fastener and object to the tree, a drill (e.g., a cordless drill) is used to drill a small hole into the tree 11 (rather than using a screw or nailing it through the tree 11). The hole can be slightly smaller in diameter than that of the shaft 14. If the bark 11A is thick or shaggy, an axe or draw shave may be used to remove excess bark 11A. The live bark would not be exposed. The object 16 is then positioned proximal the hole. The shaft 14 of the fastener 10 may then be inserted into the tree 11 (through the object 16) using a hammer, a light mallet or hand pressure, with the shaft frictionally engaging with the growth rings 11D to maintain it and the object 16 in position.

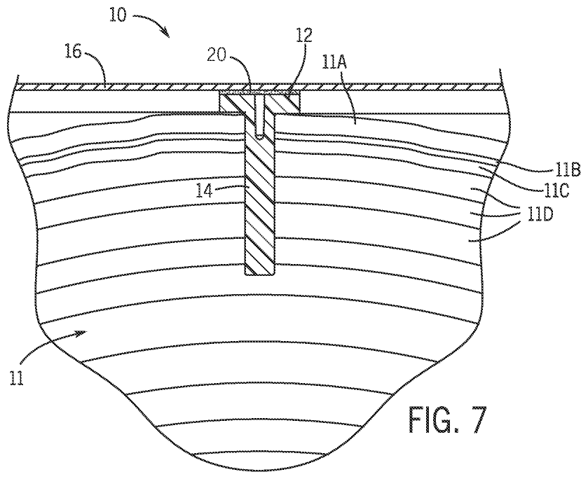

Over time, and as shown in FIG. 6, the tree 11 grows additional growth rings 11E. Due to the design and material of the fastener 10, it does not degrade over time (as opposed to metals which are prone to rusting). As the tree grows 11 and new growth rings 11E form, the self-lubricating or lubricated shaft 15 can slide through the tree trunk 11 as the head 12 and object 16 are urged further outwardly by the bark 11A. As shown in FIG. 6, a void 18 is left behind in the older growth rings 11D where the original hole was drilled, and an end tip of the shaft 14 touches a growth ring different from what it was originally (due to the expansion of the tree 11). Thus, the fastener 10 is maintained in engagement with the tree 11, and the fastener 10 protects the attached object 16 from damage caused by a nail or screw head being pulled therethrough (which would otherwise happen) and without any residual hardware being engulfed by the tree growth.

FIG. 7 depicts a potential reconfiguration of these previously described components. Rather than forming a hole through the object 16, the object may be adhered to the outermost distal end of the fastener 10 using an adhesive 21. In certain embodiments, the adhesive 21 may be a high strength, UV resistant adhesive, such as Amazing GOOP Marine. This configuration has a number of advantages. For example, there is no need to drill a hole through the sign or other object 16, which means that no text or images will be obscured by the fastener 10. As another example, the head 12 won't be exposed to ultraviolet (UV) rays, further preventing material degradation.

As those with skill in the art will appreciate, the fastener of the present invention could also be used to attach objects to any surface that could be drilled, e.g., utility poles, masonry, etc., and as mentioned above, a reflector, wire attachment or letters or symbols could also be incorporated into the design. In addition, the head 12 could incorporate a recess 20 allowing attachment of a sign, insulator or another object with a screw, adding further versatility to the fastener 10. As shown in FIGS. 5-6, the recess 20 extends through a central portion of the head 20 and into a portion of the shaft 14.

While one or more preferred embodiments are disclosed, many other implementations will occur to one of ordinary skill in the art and are all within the scope of the invention. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. Other arrangements, methods, modifications, and substitutions by one of ordinary skill in the art are therefore also considered to be within the scope of the present invention, which is not to be limited except by the claims that follow.

While apparatuses and methods are described in terms of “comprising,” “containing,” or “including” various components or steps, the apparatuses and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted. Moreover, the use of directional terms such as above, below, upper, lower, upward, downward, left, right, and the like are used in relation to the illustrative embodiments as they are depicted in the figures, the upward or upper direction being toward the top of the corresponding figure and the downward or lower direction being toward the bottom of the corresponding figure.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

What is claimed is:

1. A method of connecting an object to a tree, the method comprising the steps of:
providing a fastener comprising a head, a non-threaded shaft and a polymer material;
forming a hole in the tree;
positioning the object against the tree proximal the hole;
inserting the fastener through the object such that:
the head of the fastener substantially abuts the object,
the object substantially abuts bark of the tree, and
the shaft terminates at a first growth ring of the tree,
whereby the fastener maintains the object in connection with the tree.

2. The method of claim 1, whereby the fastener maintains the object in connection with the tree as the tree grows one or more new growth rings.

3. The method of claim 2, wherein, after the tree grows the one or more new growth rings, the shaft terminates at a second growth of the tree.

4. The method of claim 1, wherein the fastener is slidable in the hole in the tree as the tree grows one or more new growth rings.

5. The method of claim 4, wherein a void is defined beyond the fastener as the fastener slides in the hole.

6. The method of claim 4, wherein the head is sized to distribute a force applied by a growing cambium layer of the tree, the growing cambium layer causing the fastener to slide in the hole.

7. The method of claim 1, wherein the fastener is formed from high-density polyethylene.

8. The method of claim 1, wherein the fastener defines a recess through the head and extending into a portion of the shaft.
